(19) United States
(12) Patent Application Publication
(10) Pub. No.: US 2009/0027609 A1
(43) Pub. Date: Jan. 29, 2009

(54) SUBSTRATE FOR DISPLAY PANEL AND LIQUID CRYSTAL DISPLAY PANEL WITH THE SAME

(76) Inventors: Kang-Woo KIM, Seoul (KR); Ji-Yoon Jung, Cheonan-si (KR); Kyung-Wook Kim, Seoul (KR); Yeon-sik Ham, Suwon-si (KR); Jun-Hyup Lee, Seoul (KR); Yoon-Sung Um, Yongin-si (KR); Dong-Gi Seong, Seongnam-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/174,547

(22) Filed: Jul. 16, 2008

(30) Foreign Application Priority Data
Jul. 23, 2007 (KR) 10-2007-0073700

(51) Int. Cl. G02F 1/1333

(52) U.S. Cl. 349/158; 428/1.62

(57) ABSTRACT

A liquid crystal display that includes a first substrate having a thin film transistor, a common electrode, and a pixel electrode, and a second substrate is presented. The second substrate has one side with a transparent conductive layer and an insulating layer covering the transparent conductive layer, and the other side facing the first substrate. A liquid crystal layer is between the first substrate and the second substrate. Static electricity generation can be prevented by forming the transparent conductive layer on a substrate where the common electrode and the pixel electrode are not formed. Also, the transparent conductive layer is protected from damage by forming the insulating layer on the transparent conductive layer.

### CROSS-REFERENCE TO RELATED APPLICATION

This application claims priority to and the benefit of Korean Patent Application No. 10-2007-0073700 filed in the Korean Intellectual Property Office on Jul. 23, 2007, the entire content of which is incorporated herein by reference.

### BACKGROUND OF THE INVENTION

(a) Field of the Invention

The present invention relates to a substrate for a display panel and a liquid crystal display panel having the same. More particularly, the present invention relates to a substrate for a display panel having pixel electrodes and a common electrode formed on a thin film transistor substrate, and a liquid crystal display panel having the same.

(b) Description of the Related Art

A liquid crystal display shows images by controlling light transmittance of liquid crystals using an electric field. For this purpose, a liquid crystal display panel includes a thin film transistor substrate and a cover substrate with liquid crystals interposed therebetween. The liquid crystal display shows images using light transmittance that changes according to movements of liquid crystal molecules, which are caused by an electric field that is generated by applying a voltage to electrodes between two substrates.

Such a liquid crystal display has various display modes according to alignment of the liquid crystal molecules. Among them, a twisted nematic (TN) mode, a patterned vertical alignment (PVA) mode, and an electrically controlled birefringence (ECB) mode have been mainly used due to process excellence. The TN, PVA, and ECB mode liquid crystal displays have a vertical alignment (VA) mode where liquid crystal molecules are aligned almost vertically to a substrate when a voltage is applied to liquid crystal molecules that were initially aligned horizontally to the substrate. Therefore, the TN, PVA, and ECB mode liquid crystal displays have a problem of the viewing angle becoming narrow when a voltage is applied because of refractive anisotropy of the liquid crystal molecules.

In order to solve such a viewing angle problem, various modes of liquid crystal display elements having wide viewing angle characteristics have been introduced. Among them, an in plane switching (IPS) mode and a plane to line switching (PLS) mode are representative thereof. The IPS mode aligns liquid crystal molecules on a plane by forming at least a pair of electrodes in parallel in a pixel and inducing a horizontal electric field that is substantially parallel with the substrate. The PLS mode includes a common electrode and pixel electrodes with an insulating layer interposed therebetween in each pixel area, and moves liquid crystal molecules filled between a top substrate and a bottom substrate in each pixel area by forming a fringe electric field. Therefore, the PLS mode improves an aperture ratio and transmittance by forming vertical and horizontal electric fields.

That is, the PLS mode has a structure that forms vertical and horizontal electric fields using a common electrode and pixel electrodes formed on a thin film transistor substrate. Therefore, a cover substrate thereof does not include a common electrode. Since the cover substrate does not include electrodes in the IPS and PLS mode, the IPS mode and the PLS mode have a problem of easy generation of static electricity.

When an electrode layer is formed in order not to generate static electricity at the cover substrate in the IPS and PLS modes, defects may be generated in a manufacturing process due to scratches made by conveyor rollers, stains, and chemicals because the electrode layer is disposed at a rear side of the cover substrate.

### SUMMARY OF THE INVENTION

The present invention has been made in an effort to provide a liquid crystal display panel having advantages of preventing static electricity generation by forming a transparent conductive layer on a substrate not having a common electrode or pixel electrodes and preventing damage to the transparent conductive layer by forming an insulating layer on the transparent conductive layer.

The present invention has also been made in an effort to provide a substrate for a display panel having advantages of preventing static electricity generation by forming a transparent conductive layer on a substrate not having a common electrode or pixel electrodes and preventing damage to the transparent conductive layer by forming an insulating layer on the transparent conductive layer.

The present invention has further been made in an effort to provide a liquid crystal display panel having advantages of maximizing transmittance by determining a thickness of a layer in consideration of a refractive index difference between a transparent conductive layer and an insulating layer.

An exemplary embodiment of the present invention provides a liquid crystal display panel including a first substrate, a second substrate, and a liquid crystal layer. The first substrate includes a thin film transistor, a common electrode, and pixel electrodes. The second substrate includes one side having a transparent conductive layer and an insulating layer covering the transparent conductive layer, and the other side facing the first substrate. The liquid crystal layer is filled between the first substrate and the second substrate.

The transparent conductive layer may be made of at least one of indium tin oxide, indium zinc oxide, and tin oxide. The insulating layer may be made of at least one of organic or inorganic materials such as SiNx, SiOx, and SiOF.

The thickness of the transparent conductive layer may be about 200 Å to 500 Å, and the thickness of the transparent insulating layer may be about 3500 Å to 4500 Å.

The thickness of the transparent conductive layer may be about 1200 Å to 1400 Å, and the thickness of the transparent insulating layer may be about 2500 Å to 3500 Å.

The liquid crystal display panel may further include at least one insulating layer between the common electrode and the pixel electrode.

The common electrode and the pixel electrode may be formed in the same layer.

The liquid crystal display panel may further include a color filter formed on the other side of the second substrate.

Another exemplary embodiment of the present invention provides a substrate for a display panel includes a transparent substrate, a transparent conductive layer, and an insulating layer. The transparent conductive layer is formed on one side of the transparent substrate, and the insulating layer is formed on the transparent conductive layer.

The transparent conductive layer may be made of at least one of indium tin oxide, indium zinc oxide, and tin oxide.

The insulating layer may be made of at least one of SiNx, SiOx, and SiOF.

The thickness of the transparent conductive layer may be about 200 Å to 500 Å, and the thickness of the insulating layer may be about 3500 Å to 4500 Å.

The thickness of the transparent conductive layer may be about 1200 Å to 1500 Å, and the thickness of the insulating layer may be about 2500 Å to 3500 Å.

The substrate may further include a color filter formed on the other side of the transparent substrate.

According to the present invention, generation of static electricity is prevented by forming a transparent conductive layer on a substrate not having a common electrode or pixel electrodes, and damage to the transparent conductive layer is prevented by forming an insulating layer on the transparent conductive layer.

Further, transmittance is maximized by determining a thickness of a layer in consideration of a refractive index difference between the transparent conductive layer and the insulating layer.

### BRIEF DESCRIPTION OF THE DRAWINGS

FIG. 1 is a perspective view of a liquid crystal display panel according to an exemplary embodiment of the present invention.

FIG. 2 is a plan view of a liquid crystal display panel according to the first exemplary embodiment of the present invention.

FIG. 3 is a cross-sectional view of FIG. 2 taken along the line III-III.

FIG. 4 is a graph showing transmittance variation according to the thickness of a transparent conductive layer and the thickness of a transparent insulating layer according to the present invention.

FIG. 5 is a cross-sectional view of a liquid crystal display panel according to the second exemplary embodiment of the present invention.

### DESCRIPTION OF REFERENCE NUMERALS INDICATING PRIMARY ELEMENTS IN THE DRAWINGS

| | |
|---|---|
| 1: liquid crystal display panel | |
| 100: first substrate | 110: first transparent substrate |
| 121: gate line | 122: gate electrode |
| 151: passivation layer | 152: contact hole |
| 161: pixel electrode | 171: common electrode |
| 200: second substrate | 210: second transparent substrate |
| 230: color filter | 240: column spacer |
| 250: transparent conductive layer | 251: insulating layer |

### DETAILED DESCRIPTION OF THE EMBODIMENTS

Hereinafter, exemplary embodiments of the present invention will be described in detail with reference to accompanying drawings.

Like reference numerals designate like elements in exemplary embodiments. For the same constituent elements, they are representatively described for the first exemplary embodiment, and descriptions thereof may be omitted for other exemplary embodiments.

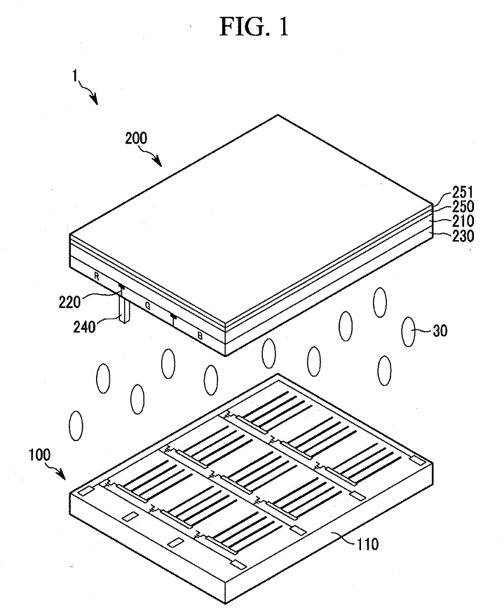

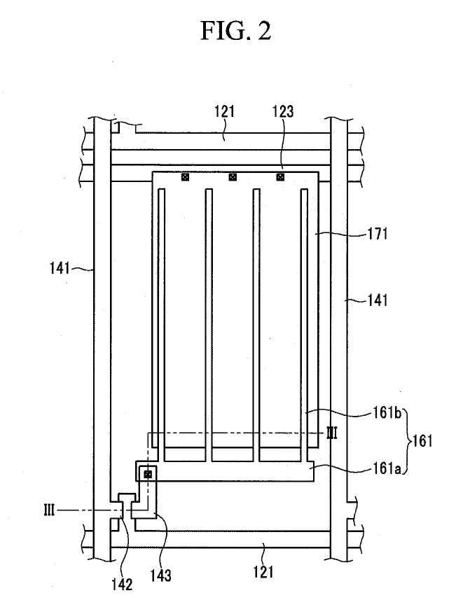

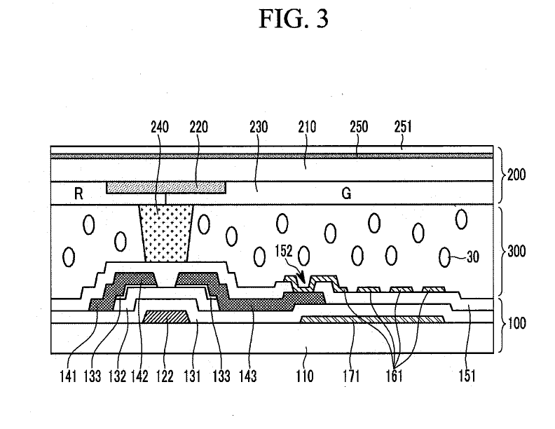

FIG. 1 is a perspective view of a liquid crystal display panel according to an exemplary embodiment of the present invention, FIG. 2 is a plan view of a liquid crystal display panel according to the first exemplary embodiment of the present invention, and FIG. 3 is a cross-sectional view of FIG. 2 taken along the line III-III.

The liquid crystal display panel 1 according to the first exemplary embodiment of the present invention is a PLS mode, which is a vertical and horizontal electrode field mode.

Referring to FIG. 1 to FIG. 3, the liquid crystal display panel 1 includes a first substrate 100 having a thin film transistor array, a second substrate 200 facing the first substrate 100, and a liquid crystal layer 300 formed between the first substrate 100 and the second substrate 200.

Liquid crystals 30 in the liquid crystal layer 300 are made of a material having dielectric anisotropy and refractive anisotropy, and are aligned in a horizontal direction by a horizontal electric field formed between a common electrode 171 and a pixel electrode 161 of the first substrate 100.

The first substrate 100 includes a first transparent substrate 110, a gate electrode 122, a common electrode 171, a gate insulating layer 131, a semiconductor layer 132, an impurity-doped ohmic contact layer 133, a source electrode 142, a drain electrode 143, a passivation layer 151, and the pixel electrode 161.

Gate wires 121, 122, and 123 and the common electrode 171 are formed on the first transparent substrate 110. The gate wires 121, 122, and 123 are made of a metal such as Cr or a Cr alloy, Al or an Al alloy, Mo or a Mo alloy, and Cu or a Cu alloy, and are formed of a single layer or as multi-layers. The gate wires 121, 122, and 123 include a gate line 121 disposed in a display area and extending in a horizontal direction, a gate electrode 122 connected to the gate line 121, and a common voltage line 123 connected to the common electrode 171 for supplying a common voltage to the common electrode 171.

A gate insulating layer 131 is formed on the gate electrode 122 and the common electrode 171 for insulating the gate electrode 122 and the common electrode 171 from a data line 141. The gate insulating layer 131 is made of organic or inorganic materials such as SiNx or SiOx.

The semiconductor layer 132 is formed on the gate insulating layer 131. The semiconductor layer 132 forms a channel as a charge transfer path of the thin film transistor (TFT), and the ohmic contact layer 133 is formed on the semiconductor layer 132 as an electrically resistive layer. Here, the semiconductor layer 132 and the ohmic contact layer 133 may be an amorphous semiconductor or a crystalline semiconductor. Data wires 141, 142, and 143 are formed on the ohmic contact layer 133 and the gate insulating layer 131. The data wires 141, 142, and 143 may also be made of a metal layer in a form of a single layer or a multi-layer. The data wires 141, 142, and 143 include a data line 141 formed in a vertical direction and crossing the gate line 121 so as to form a pixel, a source electrode 142 branching from the data line 141 and extending to an upper part of the ohmic contact layer 133, and a drain electrode 143 separated from the source electrode 142 and formed above an ohmic contact layer 133 formed on the other side of the source electrode 142.

The data wires 141, 142, and 143 are made of a metal such as Cr or a Cr alloy, Al or an Al alloy, Mo or a Mo alloy, and Cu or a Cu alloy in a form of a single layer or a multi-layer.

The passivation layer 151, which is an insulating layer, is formed on the source electrode 142, the drain electrode 143, the semiconductor layer 132, and the gate insulating layer 131 for protecting a channel unit of a thin film transistor (TFT).

The passivation layer 151 is formed as a single layer made of organic or inorganic materials such as SiNx or as a multi-layer made of organic or inorganic materials. The pixel electrode 161 is formed on the passivation layer 151 for applying a pixel voltage to the liquid crystal layer 300.

The pixel electrode 161 is made of a transparent metal such as indium tin oxide (ITO) or indium zinc oxide (IZO), and is electrically connected to the drain electrode 143 through a contact hole 152 formed in the passivation layer 151 for receiving a data voltage.

The pixel electrode 161 includes a first subpart 161a and second subparts 161b. The first subpart 161a is in parallel with the gate line 121 and connected to the drain electrode 143. The second subparts 161b extends from the first subpart 161a in parallel with the data line 141. A plurality of second subparts 161b are disposed at regular intervals.

Like the gate line 121, the common electrode 171 is formed on the first transparent substrate 110 and receives a common voltage from the common voltage line 123. The common electrode 171 is widely formed in a plate shape, unlike the pixel electrode 161. However, a plurality of common electrodes 171 may be disposed at regular intervals, similar to the pixel electrodes 161.

Each pixel electrode 161 is connected to a drain electrode 143 of the thin film transistor (TFT), and a gate insulating layer 131 and a passivation layer 151 are disposed between the pixel electrode 161 and the common electrode 171. However, only one of the gate insulating layer 131 and the passivation layer 151 may be formed between the pixel electrode 161 and the common electrode 171. Similar to the pixel electrodes, the common electrode 171 is made of a transparent metal such as ITO or IZO and is connected to the common voltage line 123 for receiving a common voltage. The common electrode 171 forms a fringe field with the pixel electrode 161. As a result, the common electrode 171 forms vertical and horizontal electric fields.

The second substrate 200 includes a black matrix 220, and red, green, and blue color filters 230 on a second transparent substrate 210. The color filters 230 may be formed on the first substrate 100 instead of the second substrate 200.

A column spacer 240 is formed on the second substrate 200 in order to sustain an interval between the second substrate 200 and the first substrate 100.

The black matrix 220 is formed at the second transparent substrate 210. The black matrix 220 may be made of a metal such as Cr or polymer resin in a form of a single layer or a multi-layer. The red, green, and blue color filters 230 are formed by pixel on the black matrix 220 for expressing color.

The column spacer 240 is formed on the color filter 230 having the black matrix 220 and sustains an interval between the second substrate 200 and the first substrate 100. The column spacer 240 may be formed on the first substrate 100 instead of the color filter 230.

A transparent conductive layer 250 and an insulating layer 251 covering the transparent conductive layer 250 are formed on an outer side of the second transparent substrate 210.

Tin oxide, indium zinc oxide, or indium tin oxide may be used as a material of the transparent conductive layer 250. Also, the transparent conductive layer 250 may be made of the same material as the common electrode 171.

The insulating layer 251 is formed to be transparent, and SiNx, SiOx, or SiOF may be used as the material of the insulating layer 251.

The multi-layer structure including the insulating layer 251 and the transparent conductive layer 250 induces reflection of light due to a refractive index difference between layers. Therefore, such a phenomenon results in loss of transmitted light that passes through the liquid crystal layer 300. That is, transmittance decreases. Therefore, it is preferable to form the transparent conductive layer 250 and the transparent insulating layer 251 to have a predetermined thickness that minimizes the transmittance loss in consideration of each refractive index.

Therefore, it is possible to prevent generation of static electricity and to allow electrostatic chuck (ESC) mode chucking by forming the transparent conductive layer 250 on the second substrate 200 not having the common electrode 171 and the pixel electrode 161. Furthermore, it is also possible to prevent defects caused by scratches made by conveyor rollers, stains, and chemicals in a manufacturing process by forming the insulating layer 251 on the transparent conductive layer 250.

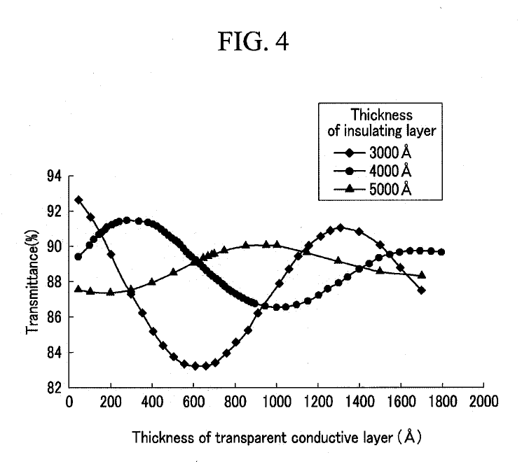

FIG. 4 is a graph showing transmittance variation as a function of the thickness of a transparent conductive layer 250 when an insulating layer 251 is formed to have thicknesses of 3000 Å, 4000 Å, and 5000 Å. In an exemplary embodiment for measuring transmittance variation, indium zinc oxide was used as a material of the transparent conductive layer 250, and SiNx was used as a material of the insulating layer 251. As shown in the graph, the highest transmittance is observed when the thickness of the insulating layer 251 is about 4000 Å and the thickness of the transparent conductive layer 250 is about 300 Å. According to the measuring result of the graph, more than 90% transmittance may be secured if the insulating layer 251 is formed to have a thickness of 4000 Å and the transparent conductive layer 250 is formed to have a thickness of about 200 to 400 Å, or if the insulating layer 251 is formed to have a thickness of 3000 Å and the transparent conductive layer 250 is formed to have a thickness of about 1200 to 1500 Å. About 90% of transmittance may be secured if the insulating layer 251 is formed to have a thickness of 5000 Å and the transparent conductive layer 250 is formed to have a thickness of about 800 to 1000 Å.

Although it is not shown, it is also possible to secure a transmittance higher than 90% if the insulating layer 251 is formed to have a thickness of about 3500 to 4500 Å and the transparent conductive layer 250 is formed to have a thickness of about 200 to 400 Å. If the insulating layer 251 is formed to have a thickness of about 2500 to 3500 Å and the transparent conductive layer 250 is formed to have a thickness of about 1200 to 1500 Å, it is also possible to secure above 90% transmittance. Furthermore, it is possible to secure about a 90% transmittance if the insulating layer 251 is formed to have a thickness of about 4500 to 5500 Å and if the transparent conductive layer 250 is formed to have a thickness of about 800 to 1000 Å.

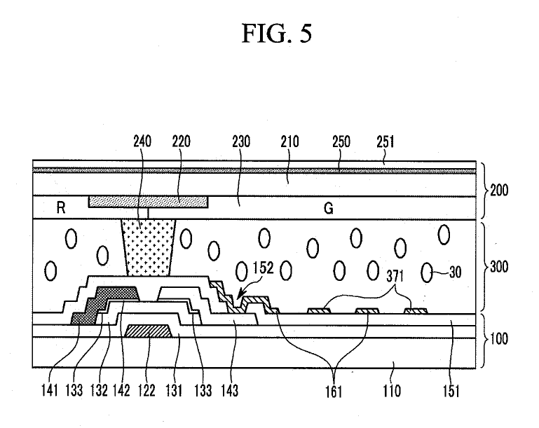

FIG. 5 is a cross-sectional view of a liquid crystal display panel according to the second exemplary embodiment of the present invention. The liquid crystal display panel 1 according to the second exemplary embodiment of the present invention is a horizontal electric field mode such as an IPS mode.

Referring to FIG. 5, the liquid crystal display panel 1 includes a first substrate 100, a second substrate 200, and a liquid crystal layer 300 between the two substrates 100 and 200.

The first substrate 100 includes a gate electrode 122, a gate insulating layer 131, a semiconductor layer 132, an ohmic contact layer 133, a source electrode 142, a drain electrode 143, a passivation layer 151, and a pixel electrode 161 on a first transparent substrate 110.

The first transparent substrate 110, the gate electrode 122, the gate insulating layer 131, the amorphous semiconductor layer 132, the ohmic contact layer 133, the source electrode 142, the drain electrode 143, the passivation layer 151, and the pixel electrode 161 are identical to those of the first exemplary embodiment.

A pixel electrode 161 is formed on the passivation layer 151 for applying a pixel voltage to the liquid crystal layer 300. The pixel electrode 161 is made of a transparent metal such as indium tin oxide (ITO) or indium zinc oxide (IZO), and is electrically connected to the drain electrode 143 through a contact hole 152 on the passivation layer 151.

Meanwhile, a common electrode 371 is formed on the passivation layer 151 corresponding to the pixel electrode 161 for applying a common voltage to the liquid crystal layer 300. Like the pixel electrode 161, the common electrode 371 is made of a transparent conductor such as ITO or IZO, and receives a common voltage through a common voltage line (not shown). The common electrode 171 may be formed at the same layer and be made of the same material as the gate electrode 122. Like the pixel electrode 161, a plurality of common electrodes 371 may be prepared and disposed at regular intervals between the pixel electrodes 161.

Therefore, the common electrode 371 is formed in parallel with the pixel electrode 161, thereby forming a horizontal electric field.

The second substrate 200 is identical to that of the first exemplary embodiment. That is, a transparent conductive layer 250 and an insulating layer 251 covering the transparent conductive layer 250 are formed on an outer side of the second transparent substrate 210.

Therefore, static electricity generation can be prevented and electrostatic chuck (ESC) mode chucking can be allowed by forming the transparent conductive layer 250 on the second substrate 200 where the common electrode 171 and the pixel electrode 161 are not formed in the second embodiment of the present invention. Further, it is also possible to prevent defects caused by scratches made by conveyor rollers, stains, and chemicals in a manufacturing process by forming the insulating layer 251 on the transparent conductive layer 250.

Additionally, a multi-layer consisting of the insulating layer 251 and the transparent conductive layer 250 induces light reflection due to a refractive index difference between layers. Therefore, such a phenomenon results in loss of transmitted light that passes through the liquid crystal layer 300. That is, transmittance decreases. Therefore, it is preferable to form the transparent conductive layer 250 and the transparent insulating layer 251 to have a predetermined thickness that minimizes the transmittance loss in consideration of each refractive index.

The description of the graph of FIG. 4 for the first exemplary embodiment may be identically applied to the second exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display panel comprising:
a first substrate including a thin film transistor, a common electrode, and a pixel electrode;
a second substrate including one side having a transparent conductive layer and an insulating layer covering the transparent conductive layer, and the other side facing the first substrate; and
a liquid crystal layer between the first substrate and the second substrate.

2. The liquid crystal display panel of claim 1, wherein the transparent conductive layer is made of at least one of indium tin oxide, indium zinc oxide, and tin oxide.

3. The liquid crystal display panel of claim 2, wherein the insulating layer is made of at least one of SiNx, SiOx, and SiOF.

4. The liquid crystal display panel of claim 1, wherein the insulating layer is made of at least one of SiNx, SiOx, and SiOF.

5. The liquid crystal display panel of claim 1, wherein a thickness of the transparent conductive layer is about 200 Å to 500 Å, and a thickness of the transparent insulating layer is about 3500 Å to 4500 Å.

6. The liquid crystal display panel of claim 5, further comprising at least one insulating layer between the common electrode and the pixel electrode.

7. The liquid crystal display panel of claim 5, wherein the common electrode and the pixel electrode are formed in the same layer.

8. The liquid crystal display panel of claim 1, wherein a thickness of the transparent conductive layer is about 1200 Å to 1400 Å, and a thickness of the transparent insulating layer is about 2500 Å to 3500 Å.

9. The liquid crystal display panel of claim 8, further comprising at least one of insulating layers between the common electrode and the pixel electrode.

10. The liquid crystal display panel of claim 8, wherein the common electrode and the pixel electrode are formed in the same layer.

11. The liquid crystal display panel of claim 1, further comprising a color filter formed on the other side of the second substrate.

12. A substrate for a display panel, comprising:
a transparent substrate;
a transparent conductive layer formed on one side of the transparent substrate; and
an insulating layer formed on the transparent conductive layer.

13. The substrate of claim 12, wherein the insulating layer is made of at least one of SiNx, SiOx, and SiOF.

14. The substrate of claim 12, wherein the transparent conductive layer is made of at least one of indium tin oxide, indium zinc oxide, and tin oxide.

15. The substrate of claim 14, wherein the insulating layer is made of at least one of SiNx, SiOx, and SiOF.

16. The substrate of claim 12, wherein a thickness of the transparent conductive layer is about 200 Å to 500 Å, and a thickness of the insulating layer is about 3500 Å to 4500 Å.

17. The substrate of claim 12, wherein a thickness of the transparent conductive layer is about 1200 Å to 1500 Å, and a thickness of the insulating layer is about 2500 Å to 3500 Å.

18. The substrate of claim 12, further comprising a color filter formed on the other side of the transparent substrate.
